(19) United States
(12) Patent Application Publication
(10) Pub. No.: US 2009/0181467 A1
(43) Pub. Date: Jul. 16, 2009

(54) Method of assessing and of activating the alternative cellular energy (ACE) pathway in the therapy of diseases

(75) Inventor: William John Martin, South Pasadena, CA (US)

Correspondence Address: William John Martin, 1634 Spruce Street, South Pasadena, CA, 91030, US

(73) Assignee: MI Hope Inc. dba Progressive University, South Pasadena, CA (US)

(21) Appl. No.: 12/009,195

(22) Filed: Jan. 16, 2008

(51) Int. Cl. G01N 21/75

(52) U.S. Cl. 436/172

(57) ABSTRACT

Alternative cellular energy pigments (ACE-pigments) provide a source of cellular energy other than that provided through the oxidative metabolism of foods, or in the case of plants and certain bacteria, through the process of photosynthesis. In some patients, ACE pigments exist in a form that can be further energized or activated using ultraviolet (UV) light, especially if the reaction is initially triggered by the presence of suitable dyes, such as neutral red. A method is described to assess the energy status of the ACE pathway in an individual or animal and also a method that involves the use of UV light in conjunction with a suitable dye, for activating the pathway in those individuals or animals in which the pathway is not fully charged. Kits for these purposes are also described.

### CROSS REFERENCE TO RELATED APPLICATIONS

### Co-Pending Patent Application

Methods for Detection of Ultraviolet Light Reactive Alternative Cellular Energy Pigments (ACE-pigments) William John Martin Submitted Dec. 24, 2007

Method of Activating the Alternative Cellular Energy (ACE) Pathway in the Therapy of Herpes Virus Infections William John Martin and Sheila Calderon Submitted Dec. 26, 2007

### Previously Submitted But Now Abandoned Patent Application

Ser. No. 10/044,683. Therapy of stealth virus associated cancers and other conditions using light. William John Martin. (Abandoned)

Ser. No. 10/047,313. Therapy of stealth virus associated cancers and other conditions using medium chain triglycerides. William John Martin. (Abandoned)

Ser. No. 10/050,232. Diagnosing and monitoring the therapy of stealth virus infections based on the detection of auto-fluorescent material in hair. William John Martin. (Abandoned)

Ser. No. 10/058,480. Therapy of stealth virus associated cancers and other conditions using magnetic energy. William John Martin. (Abandoned)

Ser. No. 10/164,258 Energy supportive therapy of stealth virus associated diseases. William John Martin. (Abandoned)

Ser. No. 10/174,466 Sound therapy of stealth virus associated diseases. William John Martin. (Abandoned)

Ser. No. 10/192,936 ACE-Pigments and humic acids as energy sources. William John Martin. (Abandoned)

Submitted: Ser. No. 10/______ Methods for Collection of Alternative Cellular Energy Pigments (ACE-pigments). William John Martin. (Abandoned)

Submitted: Ser. No. 10/______ Methods for Elimination of Toxic Alternative Cellular Energy Pigments (ACE-pigments) and for Their Replacement Using Activated Humates, Including Humic and Fulvic Acids. William John Martin. (Abandoned)

### United States Patents (Awarded)

U.S. Pat. No. 5,985,546 Stealth virus detection in the chronic fatigue syndrome. William John Martin

U.S. Pat. No. 5,891,468 Stealth virus detection in the chronic fatigue syndrome. William John Martin

U.S. Pat. No. 5,753,488 Isolated stealth viruses and related vaccines. William John Martin

U.S. Pat. No. 5,703,221 Stealth virus nucleic acids and related methods. William John Martin

U.S. Pat. No. 6,368,637. Method and composition for topical treatment of viral lesions. Jon Stoneburner

### PCT (Patent Cooperation Treaty)

WO 92/20797 Stealth virus detection in the chronic fatigue syndrome. William John Martin

WO 99/34019 Stealth virus nucleic acids and related methods. William John Martin

WO 99/60101 Stealth viruses and related vaccines. William John Martin

### REFERENCES TO PUBLISHED ARTICLES

### Alternative Cellular Energy Pigments (ACE-Pigments)

1 Martin W J. Alternative cellular energy pigments mistaken for parasitic skin infestations. Exp. Mol. Path 78: 212-214, 2005.
2 Martin W J. Alternative cellular energy pigments from bacteria of stealth virus infected individuals. Exp. Mol. Path 78: 217-217, 2005.
3 Martin W J. Progressive Medicine. Exp Mol Path 78: 218-220, 2005.
4 Martin W J, Stoneburner J. Symptomatic relief of herpetic skin lesions utilizing an energy based approach to healing. Exp. Mol. Path 78: 131-4, 2005.
5 Martin W J. Etheric Biology. Exp Mol Path 78: 221-227, 2005.
6 Martin W J. Stealth Virus Culture Pigments: A Potential Source of Cellular Energy. Exp. Mol. Pathol. 74: 210-223, 2003.
7 Martin W J. Complex intracellular inclusions in the brain of a child with a stealth virus encephalopathy. Exp. Mol. Pathol. 74: 179-209, 2003.
8 Martin W J. Photons and phonons: Theoretical aspects of biophysics and potential therapeutic applications. Proceeding of Neural Therapy Workshop on Sound and Light Therapy, Seattle, Wash., Feb. 21-23, 2003.

### Adapted Viruses

1 Martin W J Chronic fatigue syndrome among physicians. A potential result of occupational exposure to stealth viruses. Explore 2001; 10: 7-10.
2 Martin W J. Stealth Viruses. Explore 2001; 10: 17-19.
3 Durie G M, Collins R. Martin W J. Positive stealth virus cultures in multiple myeloma. A possible explanation for neuropsychiatric co-morbidity. Presented at the Am. Soc. Hematology annual meeting October 2000.
4 Martin W J. Chemokine receptor-related genetic sequences in an African green monkey simian cytomegalovirus-derived stealth virus. Exp Mol Pathol. 2000; 69:10-6.
5 Martin W J., Anderson D. Stealth virus epidemic in the Mohave Valley: severe vacuolating encephalopathy in a child presenting with a behavioral disorder. Exp Mol Pathol. 1999; 66:19-30.
6 Martin W J. Melanoma growth stimulatory activity (MGSA/GRO-alpha) chemokine genes incorporated into an African green monkey simian cytomegalovirus-derived stealth virus. Exp Mol Pathol. 1999; 66:15-8.
7 Martin W J. Bacteria-related sequences in a simian cytomegalovirus-derived stealth virus culture. Exp Mol Pathol. 1999; 66:8-14.
8 Martin W J. Stealth adaptation of an African green monkey simian cytomegalovirus. Exp Mol Pathol. 1999; 66:3-7.
9 Martin W J. Cellular sequences in stealth viruses. Pathobiology 1998; 66:53-8.
10 Martin W J. Detection of RNA sequences in cultures of a stealth virus isolated from the cerebrospinal fluid of a health care worker with chronic fatigue syndrome. Case report. Pathobiology. 1997; 65:57-60.
11 Martin W J., Anderson D. Stealth virus epidemic in the Mohave Valley. I. Initial report of virus isolation. Pathobiology. 1997; 65:51-6.
12 Martin W J. Simian cytomegalovirus-related stealth virus isolated from the cerebrospinal fluid of a patient with bipolar psychosis and acute encephalopathy. Pathobiology. 1996; 64:64-6.
13 Martin W J. Stealth viral encephalopathy: report of a fatal case complicated by cerebral vasculitis. Pathobiology. 1996; 64:59-63.
14 Martin W J. Genetic instability and fragmentation of a stealth viral genome. Pathobiology. 1996; 64:9-17.
15 Martin W J. Severe stealth virus encephalopathy following chronic-fatigue-syndrome-like illness: clinical and histopathological features. Pathobiology. 1996; 64:1-8.
16 Martin W J. Stealth virus isolated from an autistic child. J Autism Dev Disord. 1995; 25:223-4.
17 Gollard R P, Mayr A., Rice D A, Martin W J. Herpesvirus-related sequences in salivary gland tumors. J Exp Clin Cancer Res., 1996; 15: 1-4.
18 Martin W J., Glass RT. Acute encephalopathy induced in cats with a stealth virus isolated from a patient with chronic fatigue syndrome. Pathobiology. 1995; 63:115-8.
19 Martin W J, et al. African green monkey origin of the atypical cytopathic ‘stealth virus’ isolated from a patient with chronic fatigue syndrome. Clin Diag Virol 1995: 4: 93-103.
20 Martin W J. Stealth viruses as neuropathogens. CAP Today. 1994; 8: 67-70.
21 Martin W J. et al. Cytomegalovirus-related sequence in an atypical cytopathic virus repeatedly isolated from a patient with chronic fatigue syndrome. Am J. Pathol. 1994; 145: 440-51.

### STATEMENT REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not applicable.

### BACKGROUND OF THE INVENTION

The invention is based on the following broad conceptual understanding on how the body can acquire cellular energy other than through the oxidative metabolism of foods. Essentially, an alternative cellular energy (ACE) pathway has been identified that is mediated by the energy converting (transducing) properties of mineral containing complexes of organic molecules, arbitrarily termed alternative cellular energy pigments (ACE pigments). Cellular energy generated by this pathway appears to provide an auxiliary defense mechanism beyond that of the immunological system, such that an inadequacy of this pathway may limit the body's capacity to overcome various infectious diseases. The ACE pathway is likely to also function in the extra energy demands associated with various other illnesses, not necessarily of infectious origin, and to, therefore, be a factor in the recovery from these diseases.

ACE pigments are envisioned as tiny batteries that can be either fully charged or not fully charged with energy. In the latter state, ACE pigments can accept additional energy from various sources, including ultraviolet (UV) light. Absorption of UV light energy is observed as the emission of visible light; a process known as fluorescence. In some patients, including patients in whom particles of ACE pigments are misdiagnosed as parasites (delusional parasitosis of Morgellon's disease) direct fluorescence of ACE pigments can be readily observed. In many patients, however, the absorption of UV light energy and the resulting fluorescence by inadequately charged ACE pigments can be strongly enhanced in the presence of certain dyes, including neutral red. ACE pigments can also interact with various other dyes, including the fluorescent dye acridine orange, yielding a multiplicity of colors that are well beyond the narrow spectrum of green light emitted solely by UV illuminated acridine orange. Once a fluorescence reaction is evoked, nearby ACE pigments, without any direct contact with the dye, will also commonly fluoresce, presumably through a physical energy transfer mechanism. This process, triggered by neutral red dye, has been successfully used in expediting the healing of active skin lesions caused by herpes simplex virus (HSV), herpes zoster virus (HZV) and human papillomavirus (HPV) infections.

Patients with various other illnesses will commonly display ACE pigments in skin and body secretions that will fluoresce under UV light illumination in the presence of freshly prepared solution of neutral red dye. Some of these additional illnesses have been attributed to infections by stealth adapted viruses that fail to provoke an anti-viral cellular immune response. Major categories of these illnesses include the chronic fatigue syndrome, fibromyalgia, psychiatric and both acute and chronic neurological illnesses, autism and both behavioral and learning disorders in children, some cases of cancer and many cases of general debilitating illness. Material that fluoresces upon the addition of neutral red can also be seen in saliva and urine of various patients. These findings have led to the development of simple methods to assess a patient's ACE pathway and to provide a clinical indication for efforts to recharge this pathway. Such efforts include the application of neutral red, either directly to the patient's skin or onto an absorbent cloth on which ACE pigments were collected. The neutral red stained, ACE pigment containing absorbent cloth can be placed on the patient's skin, such that there is no direct contact of the dye with the patient's skin. Using either method, the UV inducible fluorescence will typically extend to involve other areas of the body, consistent with an overall systemic activation of the body's ACE pathway. Beyond developing a simple means to assess the energy status of the ACE pathway in patients, the important question arose as to whether methods of activating the ACE pathway in patients with a variety of illnesses can provide clinical benefit to patients well beyond the therapy of active herpes skin lesions. The answer is affirmative leading to the discovery of a general principle and a specific method to enhance vitality and wellness of patients in whom fluorescing ACE pigments are present.

### BRIEF SUMMARY OF THE INVENTION

The invention describes a method to enhance the overall vitality and wellbeing of individuals though a method of energy-based activation of an alternative cellular energy (ACE) pathway. Alternative cellular energy pigments (ACE-pigments) can be judged as not being fully charged if they fluoresce under UV light illumination when contacted with freshly prepared neutral red dye. The lack of detectable fluorescing material from the skin, buccal swabs (saliva) or urine is presumptive evidence that the ACE pathway is either fully charged or not being called upon to the extent it is in patients in whom fluorescence material can be collected. A series of patients have been investigated in whom skin-derived, neutral red inducible-UV fluorescing material was present but no actual skin disease was observed. Additional material was subsequently collected onto an absorbent cloth, which was stained on one side with neutral red, placed over the skin areas from which the material was collected, and illuminated with UV light. Fluorescence extended to involve the patient's skin. The patients so treated consistently reported and also displayed improvements in their sense of wellbeing. This approach provides a novel method to enhance the health and fitness of individuals in whom the ACE pathway is seemingly not fully charged. It is being referred to as “jump starting” the ACE pathway.

### BRIEF DESCRIPTION OF THE DRAWINGS

Not Applicable and none included

### DETAILED DESCRIPTION OF THE INVENTION

A series of patients have been seen who have a history of recurrent herpes simplex virus (HSV) skin lesions, or a past history of herpes zoster virus (HZV) infections, but with no actual skin lesions present at the time of examination. Another series of patients were recruited from among the patients attending a chiropractic clinic for various pain or impaired mobility related conditions. Under the direction of the inventor, both groups of patients were asked to volunteer for a study on assessing and, if necessary, activating the ACE pathway. Q-tips were used to sample various areas of their skin as well as the mucosal (buccal) surface of their mouths. Urine samples were also collected. The materials were checked for direct fluorescence using a 15W ultraviolet-A light emitting spiral fluorescent light (Halco, ProLume light). The swabs were then touched against other Q-tips that were soaked in an approximately 1 mg/ml solution of neutral red. Several drops of the neutral red solution were added to the urine. The Q-tips and urine were again examined under UV-A light for discernable fluorescence compared to Q-tips exposed only to neutral red. Significant fluorescence was seen with several of the Q-tips collected from each of the patients in both patients groups, and from the buccal swabs and urine samples from all of the patients. Clinic staff similarly tested and gave negative results.

Skin areas of the patients from which fluorescing material were obtained were then wiped with absorbent cloth. These cloth was placed over areas of skin from which the material was collected, stained with neutral red, and exposed to UV-A light from spiral fluorescent bulbs. Under UV illumination, fluorescence developed in areas of skin beneath and adjacent to the stained cloth. The fluorescence lasted for varying periods of time extending in one patient to 3 hours, but generally less than 1 hour. Skin and buccal swabs, as well as urine samples collected after the period of illumination showed a markedly reduced UV fluorescence in the presence of neutral red, compared to that prior to the UV illumination. Similarly, in most patients there was no discernable fluorescing material when the patients were seen the next day. All of the patients, however, remarked at the end of period of UV illumination on a much improved sense of wellness. One chiropractic patient presented because of low back pain not only felt pain relief in this area but happily demonstrated a much fuller range of neck rotation than had been present before the period of UV activation of his ACE pigments. An 80 year old woman commented upon the relief she experienced from a chronically painful shoulder that had resulted from injuries received years earlier in a car accident. Another patient's personality transformed from expressions of anger and hostility to one of laughter and smiles. Elderly patients were noted by clinic staff to be physically more stable and less awkward in their standing, walking and in performing other movements at the end of the therapy session than at the beginning.

When seen the following day, all of the treated patients were observed to be more positive in their attitude and more socially interactive. An 18 year old who had been noted as crying and being distressed upon entering the clinic was noted the next day to be jolly, smiling and even telling jokes. Another girl with borderline mental retardation was specifically noted to be more alert and responsive when seen the next day. Invariably, there were marked reductions in the severity of the pain and restricted mobility symptoms that had brought the chiropractic patients into the clinic.

Positive personality and overall health changes were definitely seen in all patients who underwent dye/light therapy because of a prior history of recurrent herpes simplex virus (HSV) infections. Consistency these patients remarked on a sense of improved vitality both immediately after the therapy session and when seen the next day. The clinic staff members have concurred with the patients' own assessment of marked improvements in vitality and personality.

The benefits have persisted in patients interviewed beyond 2-3 weeks after a therapy session with no additional intervention. Specifically, patients have commented on more restful sleep (and for some requiring less sleep), better concentration with a renewed capacity to pre-think something through rather than act more on impulse, being less susceptible to feelings of stress and of being overwhelmed, more physical endurance and an overall enhanced vitality. One patient specifically commented that she had a menstrual period without there being the anticipated HSV outbreak. Another patient was pleasantly surprised at not having any further episodes of genital itching and irritation.

The post neutral red-UV light therapy program has since been further strengthen with a more directed program that emphasizes the importance of mental attitude (Intention), diet and other means of limiting exposure to potential toxins (Detoxification), using formulated ACE products that are categorized as Enerceuticals, and exploring other potential ways of activating the ACE pathway. This program is being referred to as a good “IDEA” and will be described in more detail in subsequent patent applications. For this application I can confidently report the general health and wellness benefits of activating the ACE pathway in patients in whom neutral red inducible, UV light fluorescing materials are present in skin and/or body fluids of patients. Even apparently healthy individuals may be helped by the described methods if they can be shown to have an inadequately charged ACE pathway. For example, athletes and entertainers may achieve better performances if their ACE pathway can be restored from a less than optimal to an optimal level of activity. Sick animals with an ACE pathway that can be further activated would also be expected to benefit using the methods described in this application. Various modifications of the actual approach taken will be apparent to those practicing this invention, yet will rely on the basic premise of an ACE pathway.

The principles, preferred embodiments and modes of operation of the present invention have been described in the foregoing specification. The invention which is intended to be protected herein, however, is not to be construed as limited to the particular forms disclosed, since they are to be regarded as illustrative rather than restrictive. Additional advantages and modifications will readily occur to those skilled in the art. Variations and changes may be made without departing from the spirit of the invention encompassed by the appended claims.

What I claim as my invention is:

1. A method for assessing whether the alternative cellular energy (ACE) pathway in an individual or animal can be activated using ultraviolet (UV) light illumination that comprises collecting onto a Q-tip or other suitable swab, a sampling of ACE pigments from the skin or bodily fluids, and determining if such materials will show an enhanced fluoresce when mixed with a suitable dye, such as neutral red or acridine orange, and illuminated with UV light.

2. A method of activating an individual or animal alternative cellular energy (ACE) pathway that comprises staining a sampling of ACE pigments from the skin or bodily fluids, illuminating the stained ACE pigments with an ultraviolet (UL) light source so as to evoke the UV inducible fluorescence of the body's ACE pathway.

3. The method of claim 1 for the purpose of monitoring the effectiveness of the method of claim 2 in achieving activation of the alternative cellular energy (ACE) pathway in an individual or animal.

4. The method of claim 2 for the purpose of enhancing the overall health and wellbeing of the individual or animal.

5. The method of claim 2 in which the goal is to suppress the likelihood of further recurrences of skin lesions caused by viruses, including herpes simplex virus (HSV) and herpes zoster virus (HZV).

6. The method of claim 2 in which the goal is to suppress the activity of and/or the likelihood of further exacerbation of illnesses caused by stealth adapted viruses that are defined as structurally modified viruses that do not evoke an effective anti-viral cellular immune response because of their lack of viral components that would normally be targeted by the cellular immune system.

7. The method of claim 2 in which the goal is to suppress the activity of and/or the likelihood of further exacerbation of illnesses caused by infectious diseases that can be resisted, at least in part, by the alternative cellular energy (ACE) pathway.

8. The method of claim 2 in which the goal is to suppress the activity of and/or the likelihood of further exacerbation of illnesses caused by non-infectious processes that can be repaired and/or their clinical signs and symptoms suppressed, at least in part, by the alternative cellular energy (ACE) pathway.

9. The method of claim 1 that comprises a kit containing one or more of the following components: an ultraviolet light source; a dye such as neutral red or acridine orange that will either enhance the fluorescence of alternative cellular energy (ACE) pigments, Q-tips, swabs, surgical towels or other suitable materials for assaying skin and body fluids for ACE pigments that can be induced to fluoresce using UV light plus the suitable dye; and a filter that selectively transmits UV light; the kit having the purpose of assessing the status of the ACE pathway in an individual or animal.

10. The method of claim 2 that comprises a kit containing one or more of the following components: an ultraviolet light source; a dye such as neutral red or acridine orange that will either enhance the fluorescence of alternative cellular energy (ACE) pigments, Q-tips, swabs, surgical towels or other suitable materials for collecting ACE pigments that can be induced to fluoresce using UV light plus the suitable dye; and a filter that selectively transmits UV light; the kit having the purpose of activating the ACE pathway in an individual or animal.
